(19) United States
(12) Patent Application Publication
(10) Pub. No.: US 2017/0017969 A1
(43) Pub. Date: Jan. 19, 2017

(54) METHODS AND SYSTEMS FOR AUDITING AND EDITING CONTENT OF AN E-COMMERCE SITE

(71) Applicant: Overstock.com, Inc., Salt Lake City, UT (US)

(72) Inventors: Nariman Noursalehi, Salt Lake City, UT (US); Amit Goyal, Salt Lake City, UT (US); Ghulam Sarwar, Salt Lake City, UT (US)

(73) Assignee: Overstock.com, Inc., Salt Lake City, UT (US)

(21) Appl. No.: 14/802,779

(22) Filed: Jul. 17, 2015

(51) Int. Cl. G06Q 30/02

(52) U.S. Cl. CPC G06Q 30/0201

(57) ABSTRACT

Methods and systems are provided for auditing and editing the content of an e-commerce site. In one embodiment, a method includes accessing data associated with a presentation of a SKU on a retailer's website using a first device. At least one parameter associated with the presentation of the SKU is then reviewed using an auditing module and it is determined whether the at least one parameter meets a required quality threshold. A report regarding the at least one parameter is then transmitted to the user. The user may then edit the content of the e-commerce site (e.g., edit an aspect of a product page), send the report to another person, or both. For example, the method and system may be used to determine if titles, images, descriptions or other aspects of the presentation of a SKU meet a desired threshold.

### BACKGROUND

Commercial transactions conducted through electronic communication (e.g., via the World Wide Web (the Web or the internet)), commonly known as “e-commerce,” have become a significant segment of the global economy. In a typical e-commerce transaction, a user may access the internet by way of a communications device (e.g., a desktop or laptop computer, a smart phone, tablet or other internet enabled device) and accesses a retailer's or service provider's e-commerce website via the internet. Once the desired e-commerce website is located, the user may search the website for the desired good or service, either by conducting a search of the website or by paging through the website content such as by using menus or links provided on the website. The user may then add the desired product or service to a virtual “shopping cart” through selection of a graphical “button” or a link associated with a graphical or textual description of the good or service. The virtual shopping cart retains a listing of the user's intended purchases and the customer can continue “shopping” by exploring the website further and visiting other product pages.

After the user indicates that all intended purchases have been added to the virtual shopping cart, the e-commerce website presents a form to the user for the user to enter personal and payment information (e.g., name, address and credit card information). Once the payment information is approved, the website presents confirmation to the user that the transaction has been completed and may provide additional information regarding a delivery schedule or methodology.

E-commerce has been a benefit to new companies as well as to traditional “brick and mortar” companies. Virtually all companies have invested in some form of online presence. In some instances, they have established their own system for conducting e-commerce. In other instances, companies have offered their goods or services through a third party e-commerce system. Many companies do both.

E-commerce may be conducted using various business models. Under one model, online sellers offer their own products to online consumers through their own proprietary e-commerce website(s). Such websites are considered proprietary because the sellers do not allow third-parties to sell products on the websites. In this model, sellers own and manage their own product inventory. For example, an online seller offers a range of products to consumers through its own proprietary e-commerce website. When a sale is made, the online seller ships the product from its inventory to the purchaser.

Additionally, in a proprietary website, a seller conventionally maintains control over the presentation of information on their own website. For example, the seller controls how products (often referred to as stock keeping units or SKUs) are displayed, characterized and priced. Additionally, the seller controls whether there is a sale, which SKUs should be included in a given sale, how the sale should be presented on the website, and the when the sale should occur.

In another model of e-commerce, a third-party e-commerce website enables multiple sellers to offer products, but under the sellers' own names. This type of third-party website may include auction-type websites and classified-type websites. In some cases, these third-party websites provide online sellers with their own virtual store fronts. But, under this model, online sellers are typically required to manage their online transactions with consumers, including payment, inventory warehousing, and shipping.

In yet another model of e-commerce, online sellers list products on third-party websites in which the third-party website makes the actual sale to the consumer but stands in between the actual vendor and the consumer and provides a familiar, trusted face and quality customer service to the consumer. This model may be referred to as a curator model, where the third-party retailer “curates” or determines what vendors to “partner” with and/or what goods to include on their website. In one curator model, the third-party retailer may take actual possession of the goods (i.e., maintain an inventory) and sell the goods for the partners through their retail website. In another curator model the third-party retailer may employ what is known as “drop-shipping” where the third party retailer offers the goods for sale through their online website, handles payment issues and customer service issues (e.g., returns or exchanges), while the partner maintains the inventory and handles issues related to shipping. Examples of online retailers employing curator models include Overstock.com and Wayfair.com.

In curator models, the third-party retailer conventionally maintains substantial control over the process of promoting and selling the goods. For example, the online retailer typically retains control of the website, with the sellers, vendors or suppliers (sometimes referred to as partners) providing information to the online retailer regarding their product. If changes need to be made regarding a particular SKU (e.g., regarding information about the product, the presentation of the product on the online retailers' website, or the offering price of the product), the partner must typically submit a request to the online retailer to effect any such changes.

Yet another model of e-commerce may be referred to as a marketplace model. Marketplace models typically involve an online retailer opening their site for suppliers or vendors to offer their products directly to the consumer through the online retailer's marketplace site and offering minimal assistance to the consumer. The online marketplace simply charges the consumers credit card and forwards the proceeds (less some agreed upon fee) and the order to the actual seller who is providing the product. For example, previously proprietary e-commerce websites owned by large retailers have opened their doors to third-party sellers.

Third-party marketplaces may be particularly advantageous to small and medium sized sellers that may not have the resources to operate an e-commerce website, although third-party marketplaces can also be advantageous to large sellers. Examples of large online retailers operating third-party marketplaces include Amazon.com, Sears.com, Walmart.com, and Buy.com.

Of course, e-commerce may include a hybrid of two or more of the various models described above. For example, some online retailers employ both a curator model and a marketplace model.

As recognized by those of ordinary skill in the art, there are inefficiencies in various aspects of a vendor, supplier or partner working through an online retailer. For example, when a seller desires to promote their product(s) through a limited time sale, substantial efforts may be required to effect such a sale or event due to the fact that the online retailer needs to work through several individuals or teams of individuals (e.g., a promotions team, an information technology team, etc.) in order to create and effect the sales event. Thus, a seller may be subject to the desires of the online retailer in terms of offering one or more products or SKUs in a sales promotion, requiring the seller to wait until the online retailer decides to offer a promotion to the sellers (e.g., a holiday sale or seasonal sale).

Various systems and approaches have been implemented in an effort to make e-commerce more user friendly and more inviting on the one hand, and more profitable and manageable on the other hand. Continual efforts are being made to improve the e-commerce experience including efforts to provide systems and methods that make the experience more effective and more profitable for those offering goods and services for sale. It is a desire of the industry to reduce inefficiencies within various e-commerce models and to provide a greater partnership among sellers and online retailers including offering technical solutions in these areas to all parties involved.

### SUMMARY OF THE DISCLOSURE

Various methods, systems and devices are disclosed herein that may be utilized in association with e-commerce. In accordance with one aspect of the invention, a computer implemented method of auditing a presentation of a stock keeping unit (SKU) on a retailer's website is provided. The method includes accessing data associated with a presentation of a SKU on a retailer's website using a first device. The method further includes reviewing at least one parameter associated with the presentation of the SKU using an auditing module. The act of reviewing at least one parameter includes determining whether the at least one parameter meets a required quality threshold and transmitting a report regarding the at least one parameter.

In one embodiment, determining whether the at least one parameter meets a required quality threshold may further include assigning a score to the at least one parameter.

In one embodiment, the method may additionally include providing a suggestion regarding alteration of the at least one parameter.

In one embodiment, the method may further include altering the at least one parameter of the SKU.

In one embodiment, the act of reviewing at least one parameter associated with the presentation of the SKU includes reviewing a title associated with the presentation of the SKU.

In one embodiment, the act of reviewing at least one parameter associated with the presentation of the SKU includes reviewing a description associated with the presentation of the SKU.

In one embodiment, the act of reviewing at least one parameter associated with the presentation of the SKU includes reviewing a specification associated with the presentation of the SKU.

In one embodiment, the act of reviewing at least one parameter associated with the presentation of the SKU includes reviewing an image associated with the presentation of the SKU.

In one embodiment, the act of data associated with a presentation of a SKU on a retailer's website using a first device includes accessing a database of a plurality of SKUs.

In one embodiment, the act of reviewing at least one parameter associated with the presentation of the SKU using an auditing module includes reviewing at least one parameter of each of multiple SKUs of the database of a plurality of SKUs.

In accordance with another aspect of the present invention, a computing device for auditing the presentation of a stock keeping unit (SKU) on a retailer's website is provided. The device comprises a processor and memory in electronic communication with the processor, wherein the memory stores computer executable instructions that when executed by the processor cause the processor to perform the acts of: accessing data associated with a presentation of a SKU on a retailer's website using a first device, reviewing at least one parameter associated with the presentation of the SKU, determining whether the at least one parameter meets a required quality threshold, and transmitting a report regarding the at least one parameter.

In one embodiment the processor, further causes the processor to provide a suggestion regarding alteration of the at least one parameter.

In one embodiment, the act of accessing data associated with a presentation of a SKU on a retailer's website using a first device includes accessing a database of a plurality of SKUs.

In one embodiment, the act of reviewing at least one parameter associated with the presentation of the SKU using an auditing module includes reviewing at least one parameter of each of multiple SKUs of the database of a plurality of SKUs.

In accordance with another aspect of the invention, a computing system for auditing the presentation of a stock keeping unit (SKU) on a retailer's website is provided. The computing system comprises: a database having information related to a plurality of SKUs on a retailer's website; a first computing device in communication with the database, wherein the first computing device includes a processor and memory in electronic communication with the processor. The memory stores computer executable instructions that when executed by the processor cause the processor to perform the acts of: accessing data associated with a presentation of a SKU on a retailer's website using a first device, reviewing at least one parameter associated with the presentation of the SKU, determining whether the at least one parameter meets a required quality threshold, and transmitting a report regarding the at least one parameter.

In one embodiment, the database is associated with a second computing device having a processor and memory, wherein the first computing device is in communication with the second computing device via a network.

In one embodiment, the second computing device is associated with operation of the retailer's website, wherein the first computing device is associated with a partner of the retailer's website and wherein the second computing device grant's access to the database to the first computing device.

In accordance with another aspect of the present invention, a non-transitory computer-readable storage medium storing computer executable instructions is provided, wherein, when executed by a processor cause the processor to perform the acts of: accessing data associated with a presentation of a stock keeping unit (SKU) on a retailer's website, reviewing at least one parameter associated with the presentation of the SKU, determining whether the at least one parameter meets a required quality threshold, and transmitting a report regarding the at least one parameter.

Any of the acts, steps, components, devices, features or aspects of the various embodiments may be combined with those of other embodiments without limitation.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a block diagram of a system in accordance with an embodiment of the present invention;

FIGS. 2 and 3 are block diagrams of devices according to various aspects of the present invention;

FIG. 4 is a diagram showing a computing system that may be used in accordance with one example embodiment of the present invention; and

FIGS. 5 and 6 are example screen shots illustrating an interface including various aspects and features associated with the present invention.

### DETAILED DESCRIPTION OF THE INVENTION

The present invention includes various embodiments directed to systems and methods for conducting e-commerce, or online transactions, such as retail sales. The systems and methods may include the use of a variety of communications devices and may be implemented using computing devices (including mobile computing devices) over a network, such as the internet, as will be described in additional detail below.

As used herein, the term “partner” may refer to any entity that offers products for sale on third-party e-commerce websites. A partner may be one of a product supplier, a seller, a distributor, a wholesaler, an importer, a manufacturer, or any other entity, or individual, offering products for sale (e.g., to retailers or to consumers on a third-party retailer's website).

As used herein, the terms “retailer” may refer to an entity that offers products for sale to consumers, sometimes referred to as end users, on a retail level. A retailer may comprise an e-commerce enterprise that offers products to consumers over a network, such as the Internet. An e-commerce enterprise may include an e-commerce computer server connected to a publicly accessible network. The e-commerce computer server hosts an e-commerce website that enables consumers to purchase products. The products offered for sale by retailers may include its own products, products purchased from partners, or products offered by partners for sale even though title to the products has not been formally transferred to the retailer.

In e-commerce, products offered by an online retailer are conventionally located by a customer by either browsing the retailer's website, or by conducting a search for a particular product on the retailer's website, although they may also be located through third party search services (e.g., Google®, Bing®, Yahoo®, etc.). In one example, a customer might search for a computer by entering a search term “laptop” into a search window on the retailer's website. This search may return numerous results that possibly match the customer's search query. Indeed it may return multiple “pages” of results, meaning that a specified number of results (e.g., 25 or 50) are listed on an initial page of search results, and a user will be required to click on a link to view one or more subsequent pages that contain additional listings. The order in which the results are presented to a consumer may be controlled to a certain degree. For example, the retailer may structure the order of results so that products with a higher margin of profitability are seen first. Other sort orders may also be used. Additionally, users may be able to sort the results according to certain criteria such as the most popular results first, the highest (or lowest) price first, or the results having the highest review scores first.

The present invention includes various embodiments directed to systems and methods for conducting e-commerce including the implementation of processes that enables suppliers (sometimes referred to as “partners”) as well as online retailers to more effectively market and sell products through an e-commerce system. The systems and methods may involve the use of a variety of communications devices and may be implemented using computing devices over a network, such as the internet, as will be described in additional detail below.

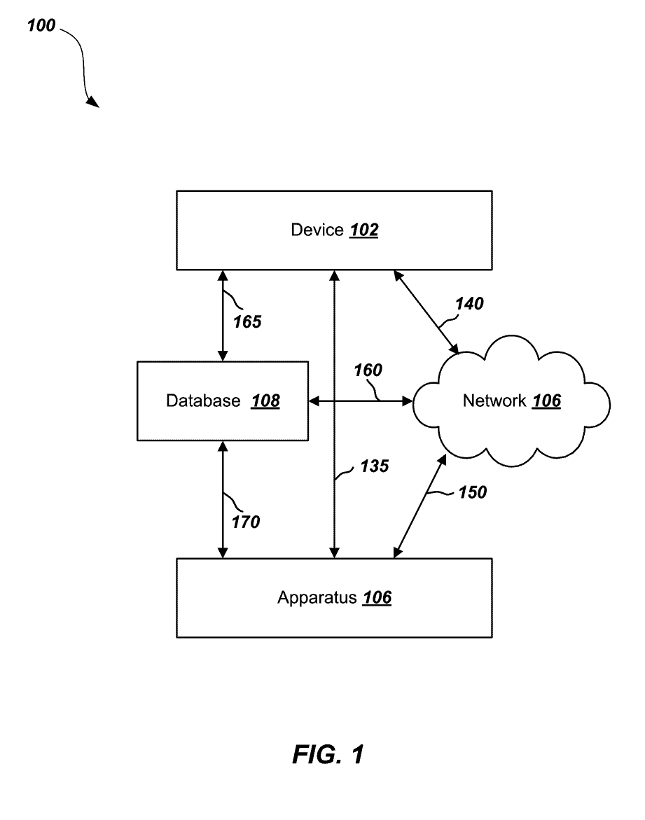

Referring initially to FIG. 1, a block diagram is shown illustrating embodiments of a system 100 in accordance with various aspects of the disclosure. System 100 may include a device 102, an apparatus 104, a network 106, and/or a database 108, among other components. The network 106 may provide and/or facilitate communication between one or more components, such as the device 102, apparatus 104, database 108, and/or other devices capable of wireless and/or wired communication. It is noted that while only individual components are shown (e.g., a single device 102, apparatus 104, or database 108), each of these components may represent multiple like components.

In some embodiments, examples of a device 102 may include, but are not limited to, a cellular phone, a personal digital assistant (PDA), a wireless communication device, a handheld device, a tablet computer, a wearable device, laptop computer, a wireless local loop (WLL) station, a display device (e.g., TVs, computer monitors, etc.), a printer, some combination, and/or the like. A device 102 may also include or be referred to by those skilled in the art as a user device, a client device, a smartphone, a BLUETOOTH® device, a Wi-Fi device, a mobile station, a subscriber station, a mobile unit, a subscriber unit, a wireless unit, remote unit, a mobile device, a wireless device, a wireless communications device, a remote device, a mobile terminal, a remote terminal, a handset, a user agent, a mobile client, a client, some combination, and or some other suitable terminology.

In some embodiments, examples of an apparatus 110 may likewise include, but are not limited to, an access point, a cellular phone, a personal digital assistant (PDA), a wireless communication device, a handheld device, a tablet computer, a wearable device, laptop computer, a cordless phone, a wireless local loop (WLL) station, a display device (e.g., TVs, computer monitors, etc.), a printer, some combination, and/or the like. An apparatus 104 may also include or be referred to by those skilled in the art as an wireless access point, a user device, a client device, a smartphone, a BLUETOOTH® device, a Wi-Fi device, a mobile station, a subscriber station, a mobile unit, a subscriber unit, a wireless unit, remote unit, a mobile device, a wireless device, a wireless communications device, a remote device, a mobile terminal, a remote terminal, a handset, a user agent, a mobile client, a client, some combination, and or some other suitable terminology.

In some embodiments, one or more components of the system 100 may attempt to and/or establish one or more communication links between other components of the system 100. As one example, in some embodiments, one or more of communication links 112 may be established between an apparatus 104 and a device 102 (and/or between multiple devices or multiple apparatuses). Similarly, communication links 114 and 116 may be established between devices 102 and the network 106 and between apparatuses 104 and the network 106. Likewise, communication links 118 and 120 may be established between the device(s) 102 and the database(s) 108, between the apparatus(es) 104 and the database(s) 108, and/or communication links 122 may be established between the network(s) 106 and the database(s) 108. Such communication links 112, 114, 116, 118, 120 and 122 may generally represent the communication route desired by a user to transmit information.

Thus, in some embodiments, a device 102 may communicate with an apparatus 104 and/or database 108 via network 120 and/or communication links, while in other embodiments, a device may be directly be in communication with an apparatus 104 and/or database by way of other communication links.

As noted above, in some embodiments, one or more devices illustrated in system 100 may communicate with and/or link to database 108. In some embodiments, database 108 may include stored settings, information, device communication, protocols, wireless traffic records and/or other information, instructions, some combination and/or other information. In some embodiments, instructions may include instructions related to information generated, transmitted, received, authenticated, modified, and/or otherwise related to at least one of device 102, apparatus 104, network 106, other components of system 100 and/or from other systems or from some combination thereof.

In some embodiments, database 108 may be internal or external to one or more components of the system 100, (e.g., connected to a device 102 or apparatus 104 through network 108, connected to such components directly, and/or contained within or otherwise integrated with one or more components of the system 100). Thus, in one example, at least a portion of database 108 may be internal and/or external to other components of system 100, such as an apparatus 104 and/or a device 102. In some embodiments, database 125 may be internal and/or external to one or more remote servers which may also be a component of the system 100 (whether or not they contain or relate to one or more databases 108).

In some embodiments, the network 108 may include cloud networks, local area networks (LAN), wide area networks (WAN), virtual private networks (VPN), wireless networks (using 802.11, for example), cellular networks (using 3G and/or LTE, for example), and/or other networks. In some embodiments, the network 108 may include the internet.

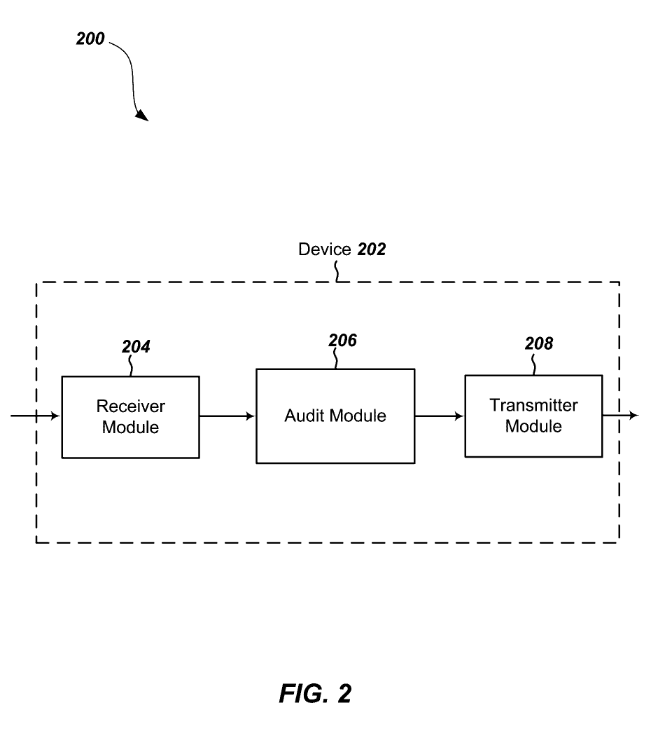

FIG. 2 shows a block diagram 200 of a device 202 for use in electronic communication, in accordance with various aspects of this disclosure. In some embodiments, the device 102 or an apparatus 104 may be an example of one or more aspects of a device 102 described with reference to FIG. 1. In some embodiments, the device 202 may be an example of one or more aspects of a database 108 described with reference to FIG. 1. In yet other embodiments, the device 202 may be an example of an access point, a remote server, a user device, a client device, some combination, and/or another one or more devices. In some embodiments, references to the device 202 relate to and/or incorporate discussion of other specifically-named devices (e.g., device 102) and/or other devices or apparatuses that may include similar and/or related characteristics or functions.

In some embodiments, such as shown in FIG. 2, the device 202 may include a receiver module 204, an audit module 206, and/or a transmitter module 208, among other things. The device 202 may also include (or be) a processor. Each of these modules may be in communication with each other directly and/or indirectly.

The components of the device 202 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 204 may receive information such as packets, user data, and/or control information associated with various information channels (e.g., control channels, data channels, etc.). The receiver module 204 may be configured to and/or capable of receiving information through wired and/or wireless connections from and/or relating to one or more components of the system 100 and/or other systems, including but not limited to one or more access points, devices 102, apparatuses 104, databases 106, remote servers, and/or information from device 202, or some combination thereof. Information may be passed on, for example, to the transmitter module 208 and/or to other components of the device 202 or the system 100.

The audit module 206 may perform one or more operations relating to an apparatus, an access point, a device, and/or a remote server (including, but not limited to, apparatus, an access point, system components, and/or a remote server), receiver module 204, transmitter module 208, and/or others modules and/or components, that may be configured to, relate to, and/or capable of performing audit-related communications, actions, operations, initiations, and/or other functions. References to a device 202 and/or audit module 206 (and variations) include all functions, features, and capabilities disclosed with respect to other apparatuses, access points, remote servers, and devices, unless otherwise specifically noted.

The transmitter module 208 may transmit one or more signals received from other components of the device 202 and/or other components of a system (e.g., system 100). The transmitter module 208 may transmit request data and/or information, monitoring data and/or information, initiation data and/or information, geographic area data and/or information, communication connection data and/or information, wireless communication related data and/or information, system event data and/or information, data that has an action performed on it, summaries, analyses, determinations, initiations, operations, instructions, alerts, statuses, errors, notification related and/or termination related data and/or information, information related to any of these and/or other applicable data and/or information types, some combination, and/or other data and/or information relating to one or more system components, network design, performance, and/or organization, and/or suspicion detection, among other things.

In some examples, the transmitter module 208 may be collocated with the receiver module 206 in a transceiver module. In other examples, the transmitter module 208 may not be collocated with the receiver module 204 in a transceiver module.

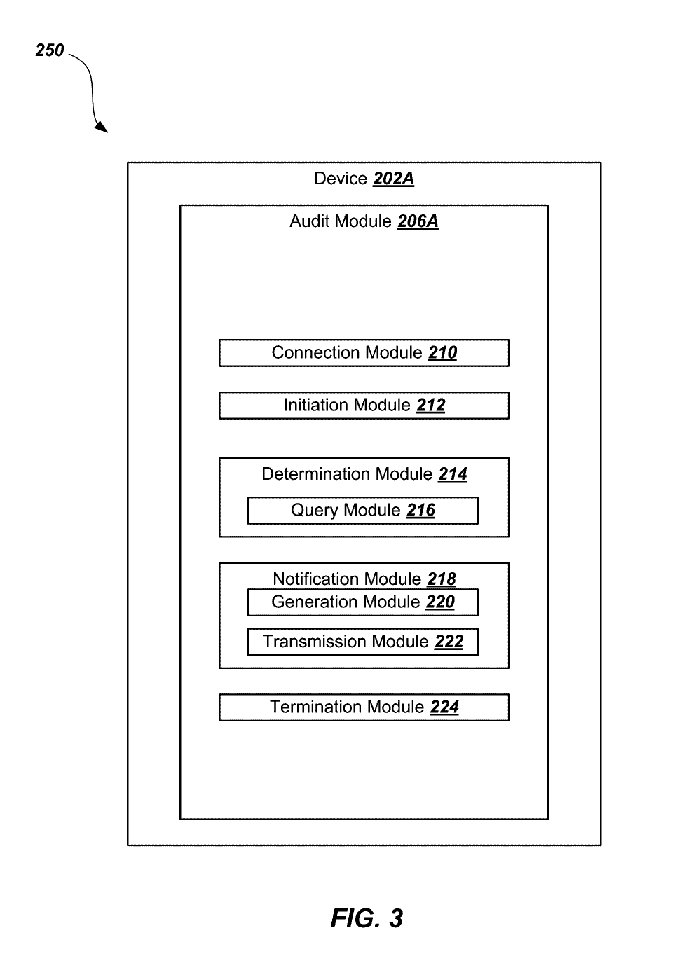

FIG. 3 shows a block diagram 250 of a device 202A for use in electronic communication in accordance with various aspects of this disclosure. The device 202A may be an example of one or more aspects of a device 102 described with reference to FIG. 1, a device 202 described with reference to FIG. 2, and others. In some embodiments, device 202A may include an audit module 206A, among others. In some embodiments, device 202A may also be or include a processor.

The components of the device 202A may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The audit module 206A may include one or more connection modules 210, initiation modules 212, determination modules 214, notification modules 218, termination modules 224, and/or other modules. The audit module 206A may also be or include a processor that executes specific, particularly-programmed instructions. Each of these modules may be in communication with each other directly and/or indirectly. The audit module 206A may be implemented to determine one or more factors, parameters, conditions or states relating to the presentation of a product or stock keeping unit (SKU) on a retailers website.

As noted above, in some embodiments, an audit module 206A may include one or more connection modules 210. In some embodiments, connection module 210 may communicate with the joined network, device, apparatus, access point and/or other components. The connection module 210 may search for and connect with a device, apparatus, network, server or database having information relating to the presentation of a SKU on a retailers website. For example, the connection module 210 may connect a device or apparatus with a server containing or providing access to a database of various SKUs hosted on a retailer's website. In one particular embodiment, the server and/or database may include a server or database specifically associated with (e.g., a server that is hosting) the retailer's website. In another embodiment, the connection module 210 may connect with a network, including the internet.

In some embodiments, audit module 202A may include one or more initiation modules 212. In some embodiments, the initiation module 212 may initiate and/or send a request relating to the network and/or an apparatus. In some embodiments, an initiation may relate to a request relating to one or more devices, apparatuses, system components, some combination, and/or other others connected by connection module 212. In some embodiments, the request may include, but is not limited to access to data associated with the presentation of one or more SKUs on a retailer's website. In one embodiment, non-limiting examples of such data or information may include, the title associated with the presentation of a SKU, the presence of keywords associated with the presentation of the SKU, the presence of relevant descriptors associated with the SKU (e.g., color, size, performance characteristics, capacities, etc.), the number of words (or characters) used in relevant descriptions of the SKU, the number and quality of customer reviews associated with the SKU, or the type and/or quality of images or videos associated with the presentation of the SKU. While such information may be accessed, for example, from a database associated with a retailer's website, in other embodiments, the initiation module 212 may initiate a search or query on a network, such as the internet, to locate and request information to the presentation of a SKU on a third parties website. In other words, such information may be accessed by “crawling” a variety of websites available on the internet.

In some embodiments, the audit module 206A may include one or more determination modules 214. In some embodiments, determination module 214 may be used to determine a whether or not the information accessed by the initiation module 212 meets a specified level of quality. In some embodiments, determination module 214 may determine that associated data (e.g., title, images, keywords, etc.) may not meet a desired threshold of quality based on specified parameters. In some embodiments, determination module 214 include a query module 216 to perform one or more operations, calculations, comparisons, analyses, functions, judgments, assessments, and/or other operations. In some embodiments, determination module 214 may perform one or more actions based at least in part on one or more requests and/or responses, whether related and/or unrelated. For example, in some embodiments, determination module 214 may compile one or more determinations (e.g., the title of a specific SKU fails to meet minimum requirements) in a report.

In some embodiments, the audit module 206A may include one or more notification modules 218. A notification module 218 may be used to notify one or more users, devices, apparatuses, network administrators, and/or others regarding the results of a determination module reviewing the quality of various information or data associated with the presentation of a SKU on a retailer's website. In some embodiments, notification module 218 may include a generation module 220 and/or a transmission module 222. In one example, the generation module 220 may be used to generate one or more notifications relating to operations performed by one or more modules of audit module 206A, including, but not limited to, determinations made by determination module 214 (e.g., reports regarding quality checks associated with various SKUs). In some embodiments, the notification module may further provide suggestions for remedying any component of data or information that has been determined to be deficient in some manner.

In some embodiments, the transmission module 222 may be used to transmit one or more notifications to a user, a device, an apparatus, a remote server, and/or other components. In some embodiments, notifications may be of different types, levels, and/or may include various types of information, including information relating to any module of the audit module 206A (among others). In some embodiments, notifications may be urgent and describe determinations indicating that the quality of certain aspects associated with the presentation of a SKU fall below a desired threshold. In some embodiments, notifications may be information and non-urgent, and describe determinations indicating that certain aspects associated with the presentation of a SKU, while meeting desired thresholds, show indications of potential improvement.

In some embodiments, suspicion module 206A may include one or more termination modules 224. For example, the termination module 224 may be used to terminate a connection made by the connection module 210 based at least in part on the one or more determinations of the determination module 224. In some embodiments, the termination module 224 may be used to terminate one or more connections made by the connection module 210 based at least in part on one or more notification received by the notification module 218.

In some embodiments, termination module 224 may automatically terminate one or more connections relating to connection module 210. In some embodiments, termination module 224 may terminate one or more connections relating to connection module 210 based at least in part on one or more notifications relating to notification module 218. In some embodiments, termination module 224 may terminate one or more connections relating to connection module 210 based at least in part on information, data, actions, instructions, requests, some combination, and/or other information received from a user, a network administrator, a device, an apparatus, and/or a component.

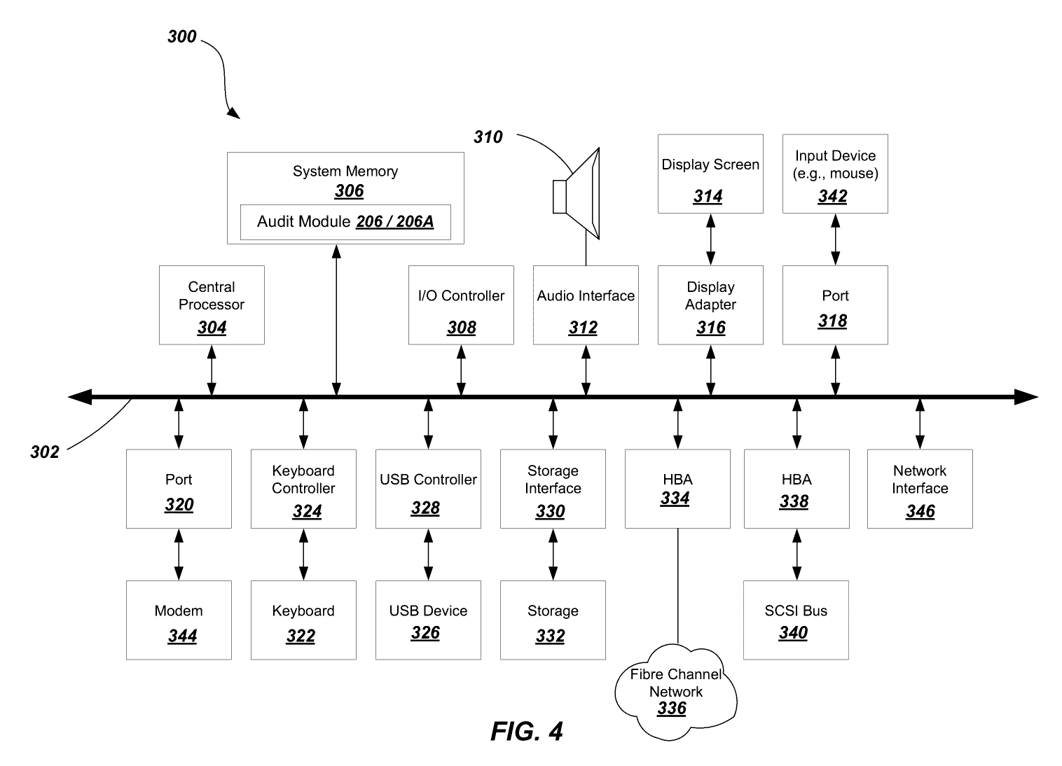

Referring now to FIG. 4, a diagram is shown of an example of a computing system that may be utilized in association with various features, aspects, components and modules described hereinabove. FIG. 4 depicts a block diagram of one example of a computer system 300 suitable for implementing the present systems and methods. Computer system 300 includes a bus 302 which interconnects major subsystems of computer system 300, such as a central processor 304, a system memory 306 (typically RAM, but which may also include ROM, flash RAM, or the like), an input/output controller 308, an external audio device, such as a speaker system 310 via an audio output interface 312, an external device, such as a display screen 314 via display adapter 316, serial ports 318 and 320, a keyboard 322 (interfaced with a keyboard controller 324), multiple USB devices 326 (interfaced with a USB controller 328), a storage interface 330, a storage device 332 (which may include a fixed disc, a floppy disc, an optical disc or other storage devices), a host bus adapter (HBA) interface card 334 operative to connect with a Fibre Channel network 336 and a host bus adapter (HBA) interface card 338 operative to connect to a SCSI bus 340. Also included are user input devices 342 (e.g., a mouse or other point-and-click device—although such devices may also be coupled to the bus 302 via a USB controller 328), a modem 344 (coupled to bus 302 via port 320), and a network interface 346 (coupled directly to bus 302).

Bus 302 allows data communication between central processor 304 and system memory 306, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. Applications resident with computer system 300 are generally stored on and accessed via a computer readable medium, such as a hard disc drive, an optical drive, a floppy disk drive, a flash memory drive or other storage medium. Additionally, applications can be in the form of electronic signals modulated in accordance with the application and data communication technology when accessed via network modem 344 or network interface 346. As shown in FIG. 4, in some embodiments, system memory 306 may include an audit module 206/206A such as described above.

Storage interface 330, as with the other storage interfaces of computer system 300, can connect to a standard computer readable medium for storage and/or retrieval of information, such as a fixed disc drive. A fixed disk drive or other storage device may be a part of computer system 300 or may be separate and accessed through other interface systems. Modem 344 may provide a direct connection to a remote server via a telephone link or to the Internet via an internet service provider (ISP). Network interface 346 may provide a direct connection to a remote server via a direct network link to the Internet via a POP (point of presence). Network interface 346 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 4 need not be present to practice the present systems and methods. The devices and subsystems can be interconnected in different ways from that shown in FIG. 4. The operation of a computer system such as that shown in FIG. 4 is readily known in the art and is not discussed in detail in this application. Code to implement the present disclosure can be stored in computer-readable medium such as one or more of system memory 306, a fixed disc, an optical disk, a floppy disc, a flash memory drive or some other storage device. The operating system provided on computer system 300 may be, for example, MS-DOS®, MS-WINDOWS®, iOS®, UNIX®, Linux®, ANDROID® or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

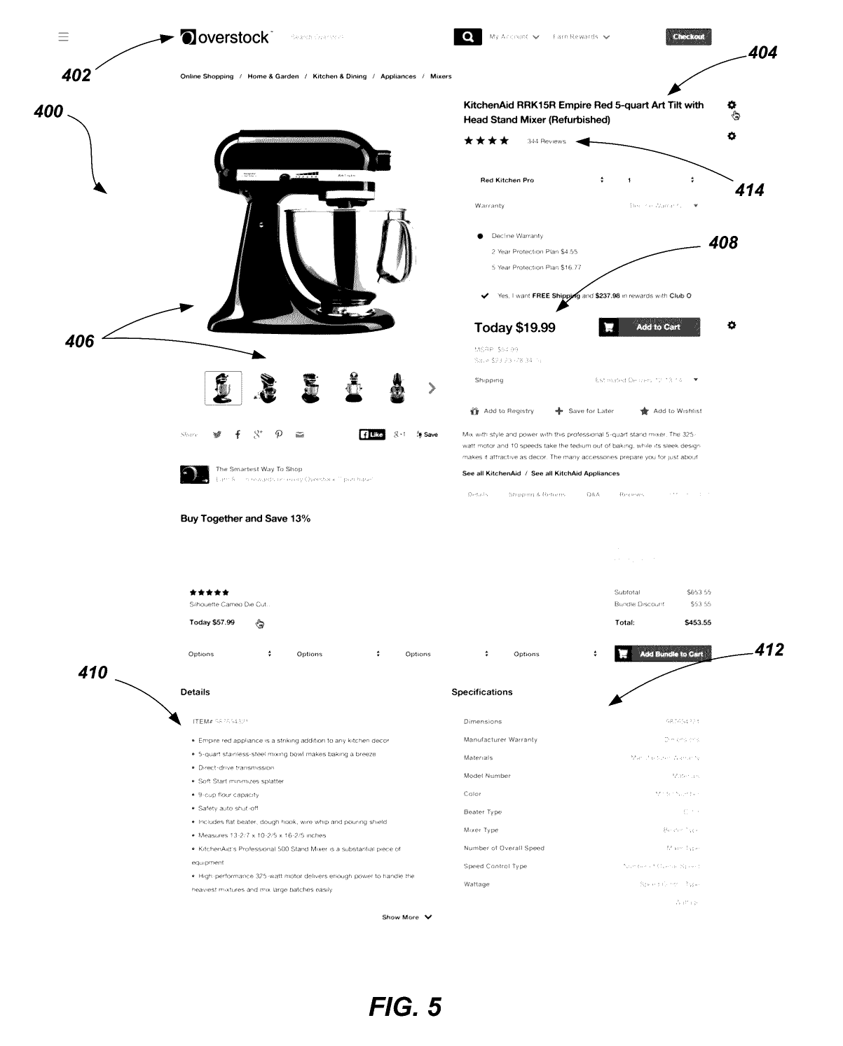

Referring now to FIG. 5, a screen shot is shown of an exemplary presentation 400 of a SKU on a retailer's website 402. The presentation 400 of the SKU may include identification of the SKU using a title 404. The presentation may further include one or more images 406 which may include, for example, still images and/or video images. Additional information may include, for example, a price 408, features or details 410, specifications 412, reviews (or a link to reviews) 414 and a variety of other information including, for example, the categorization or classification of the SKU.

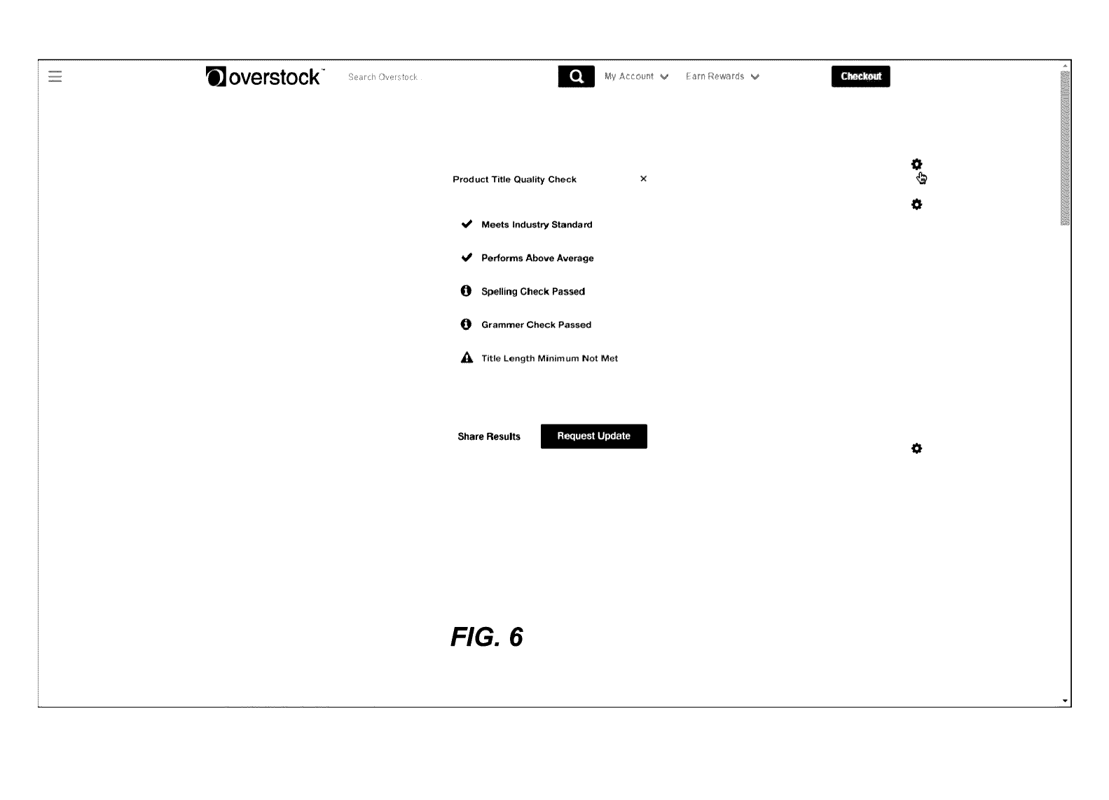

In accordance with one embodiment of the invention, a system, device or apparatus may be configured to access a website associated with the presentation 400 of the SKU, and/or access a database containing various data and information associated with the presentation 400 of the SKU, and audit the various components (e.g., title, description, specification, etc.) association with the presentation 400 of the SKU. For example, an audit module (e.g., 206 or 206A) may be used to audit such information. Such an audit module may provide a report back to the a user indicating which components of data or information meet desired quality levels and/or which components of data or information may require improvement. For example, as seen in FIG. 6, a report may be returned with regard to the title 404 associated with the presentation 400 of a SKU. The report may include information including, for example, that the title does or does not meet an industry standard (e.g., it provides appropriate classification of the SKU), whether or not the spelling and grammar are acceptable, whether that the title length meets a minimum word or character count, or other relevant criteria. Of course, similar reports may be generated for other aspects of the presentation (e.g., specification, description, image quality, etc.). Such reports may be provided to the user which may then take appropriate action including making changes or forwarding the report to another person for their consideration in making changes to the presentation 400 of the SKU.

The action to be taken in altering the presentation 400 of the SKU may be limited by permission levels if desired. If, for example, the user performing an audit on the presentation of a SKU is a copywriter, the copywriter may be limited in the types of changes that they make to the presentation of the SKU. For example, the copywriter might be permitted to make spelling or grammar changes, but not be permitted to make other changes relating to description or characterization of the SKU.

In another example, if the user was a partner offering the SKU via a retailer's website, the partner may have access to change numerous aspects of the presentation. For example, the partner may be permitted to update the images that are utilized in association with the presentation of the SKU. Additionally, the partner may provide updated specifications, descriptions, or add relevant keywords that will affect the ability of the SKU presentation to be found in a search by a consumer (e.g., a search conducted specifically on the retailer's website or a search conducted by someone using an internet search engine such as Google®, Bing® or the like). In some embodiments, the partner may even be able to alter the price associated with the presentation of the SKU or associate the SKU with an event or promotion. A partner may be able to accomplish such using systems and methods such as described in U.S. Patent Application Publication No. 2013/0041779 entitled METHODS AND SYSTEMS FOR CONDUCTING ELECTRONIC COMMERCE, and published Feb. 14, 2013, and U.S. Provisional Patent Application No. 62/155,949, entitled METHODS AND SYSTEMS FOR CONDUCTING SALES PROMOTIONS, filed May 1, 2015, the disclosures of each of which are incorporated by reference in their entireties herein.

In another example, a merchandiser or some other user with high level permission associated with the retailer may be enabled to make any changes to the presentation 400 of the SKU. Such a user may do so based on one or more reports prepared by an auditing system such as described herein, before or after consulting with a partner depending on the subject matter being altered or updated.

In some embodiments, in lieu of (or in addition to) a report regarding whether a component meets minimum requirements, a score may be provided for a particular aspect or parameter of the presentation 400 of the SKU. For example, a score on a scale of 100 (or some other number) may be provided, with the highest number being best. The score may reflect, for example, the effective use of keywords or descriptive terms, proper grammar, suggested length of description or size of image. A user may then use that score to determine whether they believe it is desirable to make an effort to improve on or more aspects of the presentation 400 of a SKU.

In some embodiments, the report provided by an auditing system may include overlays of such results, scores and/or recommendations next to the specific aspect of the presentation 400. For example, a score, recommendation or other comment regarding the title may be provided in an overlay positioned adjacent to or on top of the title, with the actual presentation 400 being faded or “greyed out” such as shown in FIG. 6. In some embodiments, an overlay may include a link to activate a pop-up image or window. A user may move from component to component (e.g., from title, to specification, to reviews, etc.) in reviewing the audit results and recommendations. Of course, other presentations of audit results, including other user interfaces, are contemplated as being within the scope of the present invention.

In auditing the presentation of a SKU, a system or device utilizing an auditing module may be configured to audit the presentation multiple SKUs. For example, the system, device and/or auditing module may be configured to audit an entire database of SKU presentations, or some filtered subset of a database. For example, a system, device or module may be configured to audit SKUs associated with a specific category or classification of goods or services being offered (e.g., clothing, men's clothing, or men's footwear). The auditing module may then be configured to generate a report to show the SKUs having the lowest scoring presentations (or SKUs having the most features/aspects needing correction or updating) for a user to subsequently address.

Systems and methods of the present invention enable users (e.g., both internal and third party users, such as partners) to quickly ascertain quality considerations associated with the presentation of various SKUs and make necessary adjustments so that the SKUs may be more readily located by search engines, attract the attention of consumers, and convert “clicks” and “views” of a SKU by a consumer to sales of the SKU.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of acts described and/or illustrated herein are given by way of example only and can be varied as desired. For example, while the acts illustrated and/or described herein may be shown or discussed in a particular order, these acts do not necessarily need to be performed in the order illustrated or discussed. The various exemplary methods described and/or illustrated herein may also omit one or more of the acts described or illustrated herein or include additional acts in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. It is additionally noted that the interface may be implemented in various forms including, for example, as a program implemented from a supplier's computing system that accesses data on the retailer's computing system or network; via the internet through a web browser; or through a retailer's server or network by way of a virtual private network that has been accessed by a supplier.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A computer implemented method of auditing a presentation of a stock keeping unit (SKU) on a retailer's website, the method comprising:
accessing data associated with a presentation of a SKU on a retailer's website using a first device;
reviewing at least one parameter associated with the presentation of the SKU using an auditing module including:
determining whether the at least one parameter meets a required quality threshold,
transmitting a report regarding the at least one parameter.

2. The method according to claim 1, wherein determining whether the at least one parameter meets a required quality threshold further includes assigning a score to the at least one parameter.

3. The method according to claim 1, further comprising providing a suggestion regarding alteration of the at least one parameter.

4. The method according to claim 1, further comprising altering the at least one parameter of the SKU.

5. The method according to claim 1, wherein reviewing at least one parameter associated with the presentation of the SKU includes reviewing a title associated with the presentation of the SKU.

6. The method according to claim 1, wherein reviewing at least one parameter associated with the presentation of the SKU includes reviewing a description associated with the presentation of the SKU.

7. The method according to claim 1, wherein reviewing at least one parameter associated with the presentation of the SKU includes reviewing a specification associated with the presentation of the SKU.

8. The method according to claim 1, wherein reviewing at least one parameter associated with the presentation of the SKU includes reviewing an image associated with the presentation of the SKU.

9. The method according to claim 1, wherein accessing data associated with a presentation of a SKU on a retailer's website using a first device includes accessing a database of a plurality of SKUs.

10. The method according to claim 9, wherein reviewing at least one parameter associated with the presentation of the SKU using an auditing module includes reviewing at least one parameter of each of multiple SKUs of the database of a plurality of SKUs.

11. A computing device for auditing the presentation of a stock keeping unit (SKU) on a retailer's website, comprising:
a processor;
memory in electronic communication with the processor, wherein the memory stores computer executable instructions that when executed by the processor cause the processor to perform the acts of:
accessing data associated with a presentation of a SKU on a retailer's website using a first device,
reviewing at least one parameter associated with the presentation of the SKU,
determining whether the at least one parameter meets a required quality threshold, and
transmitting a report regarding the at least one parameter.

12. The device of claim 11, wherein the memory, when executed by the processor, further causes the processor to provide a suggestion regarding alteration of the at least one parameter.

13. The device of claim 11, wherein accessing data associated with a presentation of a SKU on a retailer's website using a first device includes accessing a database of a plurality of SKUs.

14. The device of claim 13, wherein reviewing at least one parameter associated with the presentation of the SKU using an auditing module includes reviewing at least one parameter of each of multiple SKUs of the database of a plurality of SKUs.

15. A computing system for auditing the presentation of a stock keeping unit (SKU) on a retailer's website, comprising:
a database having information related to a plurality of SKUs on a retailer's website;
a first computing device in communication with the database, wherein the first computing device includes a processor and memory in electronic communication with the processor, wherein the memory stores computer executable instructions that when executed by the processor cause the processor to perform the acts of:
accessing data associated with a presentation of a SKU on a retailer's website using a first device,
reviewing at least one parameter associated with the presentation of the SKU,
determining whether the at least one parameter meets a required quality threshold, and
transmitting a report regarding the at least one parameter.

16. The computing system of claim 15, wherein the database is associated with a second computing device having a processor and memory, wherein the first computing device is in communication with the second computing device via a network.

17. The computing device of claim 16, wherein the second computing device is associated with operation of the retailer's website, wherein the first computing device is associated with a partner of the retailer's website and wherein the second computing device grant's access to the database to the first computing device.

18. A non-transitory computer-readable storage medium storing computer executable instructions that when executed by a processor cause the processor to perform the acts of:
accessing data associated with a presentation of a stock keeping unit (SKU) on a retailer's website,
reviewing at least one parameter associated with the presentation of the SKU,
determining whether the at least one parameter meets a required quality threshold, and
transmitting a report regarding the at least one parameter.
